(19) United States
(12) Patent Application Publication
(10) Pub. No.: US 2006/0238689 A1
(43) Pub. Date: Oct. 26, 2006

(54) Array substrate and method of manufacturing the same

(75) Inventors: Soo-Jin Kim, Seoul (KR); Dong-Ho Lee, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/407,272

(22) Filed: Apr. 19, 2006

(30) Foreign Application Priority Data
Apr. 22, 2005 (KR) 2005-33522

(51) Int. Cl. G02F 1/1343

(52) U.S. Cl. 349/143; 430/317

(57) ABSTRACT

An array substrate includes a first line, a second line and a switching element in a pixel region defined by the first and second lines adjacent to each other. The pixel electrode is electrically connected to an electrode of the switching element through a plurality of contact holes through which the electrode of the switching element is partially exposed.

### CROSS-REFERENCE TO RELATED APPLICATION

The present application claims priority from Korean Patent Application No. 2005-33522, filed on Apr. 22, 2005, the disclosure of which is hereby incorporated herein by reference in its entirety.

### BACKGROUND OF THE INVENTION

1. Technical Field

The present disclosure relates to an array substrate and a method of manufacturing the array substrate, and, more particularly, to an array substrate capable of protecting a metal line and a method of manufacturing same.

2. Discussion of the Related Art

A liquid crystal display (LCD) device includes an LCD panel and a driving circuit part that applies driving signals to the LCD panel. The LCD panel includes a plurality of gate lines, a plurality of source lines and a plurality of pixel parts. Each of the pixel parts is in a region defined by gate and data lines that are adjacent to each other. The driving circuit is mounted on pads of the LCD panel.

When the LCD device has a large screen and a highly integrated structure, a time constant RC of each of the data and gate lines is increased so that data and gate signals generated from the driving circuit are delayed, thereby deteriorating an image display quality of the LCD panel. In order to decrease the time constant, each of the data and gate lines has a multi-layered structure including aluminum and a high fusion point metal such as molybdenum.

When each of the data and gate lines includes the molybdenum, the molybdenum is etched by an etchant for etching a passivation layer.

### SUMMARY OF THE INVENTION

Embodiments of the present invention provide an array substrate capable of protecting a metal line, and a method of manufacturing the array substrate.

An array substrate in accordance with an embodiment of the present invention includes a first line, a second line and a switching element in a pixel region defined by the first and second lines adjacent to each other. The pixel electrode is electrically connected to an electrode of the switching element through a plurality of contact holes through which the electrode of the switching element is partially exposed.

The array substrate may further include an organic insulating layer covering the first and second lines. The organic insulating layer may include a reflective material. The organic insulating layer may have a multi-layered structure including at least two layers having different refractive indexes.

The array substrate may further include a first pad member including a first pad pattern and first side surfaces. The first pad pattern may be electrically connected to a first metal pattern of the first line through a plurality of first contact holes. The first side surfaces of the organic insulating layer surround the first pad pattern, and are inclined with respect to an upper surface of the organic insulating layer. The first side surfaces may have a stepped portion.

The array substrate may further include a second pad member having a second pad pattern and second side surfaces. The second pad pattern may be electrically connected to a second metal pattern of the second line through a plurality of second contact holes. The second side surfaces of the organic insulating layer surround the second pad pattern, and are inclined with respect to an upper surface of the organic insulating layer. The second side surfaces of the organic insulating layer may have a stepped portion.

Each of the first and second lines may include molybdenum. Each of the first and second lines may include a first layer including molybdenum or molybdenum alloy, and a second layer including at least one of aluminum, aluminum alloy, silver, silver alloy, copper or copper alloy.

The pixel electrode may include indium tin oxide (ITO), tin oxide (TO), indium zinc oxide (IZO), zinc oxide (ZO), indium tin-zinc oxide (ITZO), etc.

An array substrate in accordance with an embodiment of the present invention includes a pixel part and a first pad member. The pixel part includes a first line, a second line, a switching element electrically connected to the first and second lines, and a pixel electrode electrically connected to the switching element. The first pad member transmits an electrical signal to the switching element, and is electrically connected to a first metal pattern through a plurality of first contact holes. The first metal pattern is formed from substantially the same layer as the first line.

The array substrate may further include a second pad member transmitting an electrical signal to the switching element and being electrically connected to a second metal pattern through a plurality of second contact holes. In addition, the second metal pattern may be formed from substantially the same layer as the second line.

The pixel part may further include a contact part having a plurality of contact holes through which a drain electrode of the switching element is electrically connected to the pixel electrode.

The array substrate may further include an organic insulating layer covering the first and second lines.

The organic insulating layer may include a reflective material.

The organic insulating layer may have a multi-layered structure including at least two layers having different refractive indexes.

The first pad member may further include first side surfaces of the organic insulating layer, which surround the first pad pattern, and the first side surfaces may be inclined with respect to an upper surface of the organic insulating layer. The second pad member may further include second side surfaces of the organic insulating layer, which surround the second pad pattern, and the second side surfaces may be inclined with respect to an upper surface of the organic insulating layer. The first and second side surfaces may have a stepped portion.

A method of manufacturing an array substrate in accordance with an embodiment of the present invention is provided as follows. A switching element electrically connected to a line is formed in a display region of a substrate, and a metal pattern electrically connected to the line is formed in a peripheral region of the substrate. A passivation layer is formed on the substrate having the switching element and the metal pattern. The passivation layer is partially etched to form a plurality of first contact holes through which the switching element is partially exposed, and a plurality of second contact holes through which the metal pattern is partially exposed. A pixel electrode electrically connected to the switching element through the first contact holes, and a pad pattern electrically connected to the metal pattern through the second contact holes are formed.

After the partially etching the passivation layer, an organic insulating layer may be formed on the passivation layer. In addition, the organic insulating layer corresponding to the first contact holes and the metal pattern may be fully removed, and the organic insulating layer corresponding to a peripheral region of the metal pattern may be partially removed to form a stepped portion in the organic insulating layer.

The organic insulating layer may be fully removed by fully exposing the organic insulating layer corresponding to the metal pattern, and developing the fully exposed organic insulating layer.

The method may further include partially removing the organic insulating layer corresponding to the display region to form an embossed pattern.

The organic insulating layer may include a reflective material. Alternatively, the organic insulating layer may be a multi-layered organic insulating layer having various refractive indexes.

According to embodiments of present invention, the sizes of the contact holes are decreased, and the number of the contact holes is increased, thereby protecting the gate and data metal layers.

### BRIEF DESCRIPTION OF THE DRAWINGS

Preferred embodiments of the present invention can be understood in more detail from the following descriptions taken in conjunction with the accompanying drawings, in which:

FIG. 1 is a plan view showing an array substrate in accordance with an embodiment of the present invention;

FIG. 2 is an enlarged plan view of the array substrate shown in FIG. 1;

FIG. 3 is a cross-sectional view of a display panel including the array substrate taken along a line I-I′ shown in FIG. 1;

FIGS. 4 to 8 are cross-sectional views of the array substrate for showing a method of manufacturing the array substrate shown in FIG. 3;

FIG. 9 is a cross-sectional view showing a display panel in accordance with an embodiment of the present invention;

FIGS. 10 to 13 are cross-sectional views of an array substrate for showing a method of manufacturing an array substrate shown in FIG. 9;

FIG. 14 is a cross-sectional view showing a display panel in accordance with an embodiment of the present invention; and

FIGS. 15 to 17 are cross-sectional views of an array substrate for showing a method of manufacturing an array substrate shown in FIG. 14.

### DETAILED DESCRIPTION OF THE EXEMPLARY EMBODIMENTS

Exemplary embodiments of the present invention will now be described more fully hereinafter with reference to the accompanying drawings, in which embodiments of the invention are shown. This invention may, however, be embodied in many different forms and should not be construed as limited to the embodiments set forth herein.

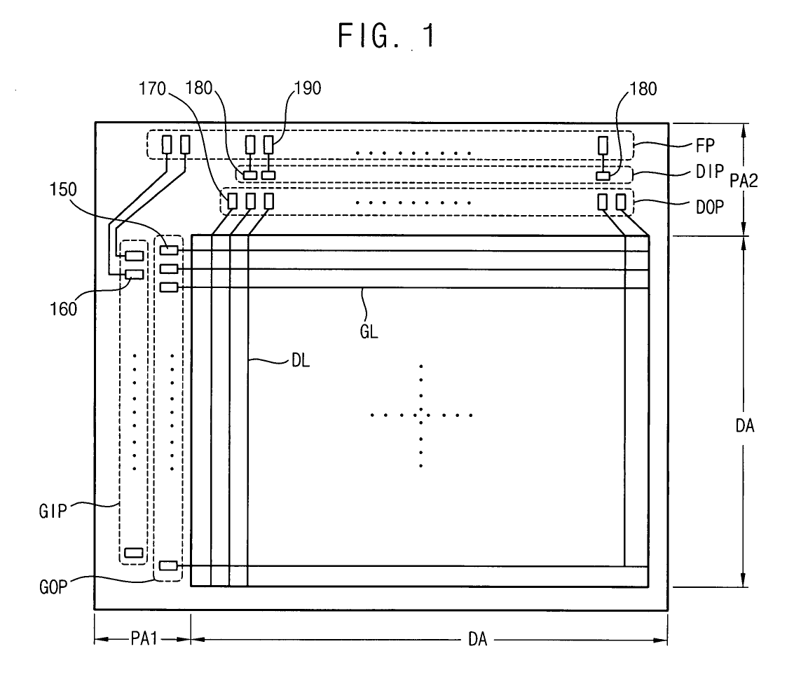

FIG. 1 is a plan view showing an array substrate in accordance with an embodiment of the present invention.

Referring to FIG. 1, the array substrate includes a display region DA, a first peripheral region PA1 and a second peripheral region PA2. An image is displayed in the display region DA. The first and second peripheral regions PA1 and PA2 are adjacent to the display region DA.

A plurality of gate lines GL and a plurality of data lines DL are in the display region DA. The gate lines GL are aligned in a first direction. The data lines DL are aligned in a second direction.

A gate output pad member GOP and a gate input pad member GIP are formed in the first peripheral region PA1. The gate output pad member GOP and the gate input pad member GIP each include a plurality of contact holes. The gate output pad member GOP includes a plurality of gate output pads 150 that are electrically connected to the gate lines GL, respectively.

The gate output pad member GOP makes contact with output terminals of a gate driving chip so that gate signals outputted from the gate driving chip are applied to the gate lines GL.

The gate input pad member GIP includes a plurality of gate input pads 160. The gate input pad member GIP makes contact with input terminals of a gate driving chip so that gate driving signals generated from an externally provided unit are applied to the gate driving chip.

A data output pad DOP, a data input pad DIP and a flexible printed circuit board (FPC) pad member FP are formed in the second peripheral region PA2. The data output pad DOP, the data input pad DIP and the FPC pad member FP each include a plurality of contact holes. The data output pad member DOP includes a plurality of data output pads 170 that are electrically connected to the data lines DL, respectively. The data output pad member DOP makes contact with output terminals of a data driving chip so that data signals outputted from the data driving chip are applied to the data lines DL.

The data input pad member DIP includes a plurality of data input pads 180. The data input pad member DIP makes contact with input terminals of a data driving chip so that data driving signals generated from an externally provided unit are applied to the data driving chip.

The FPC pad member FP includes a plurality of FPC pads 190 that are electrically connected to the flexible printed circuit board (FPC) so that the FPC is electrically connected to the gate input pad member GIP and the data input pad member DIP through the FPC pad member FP.

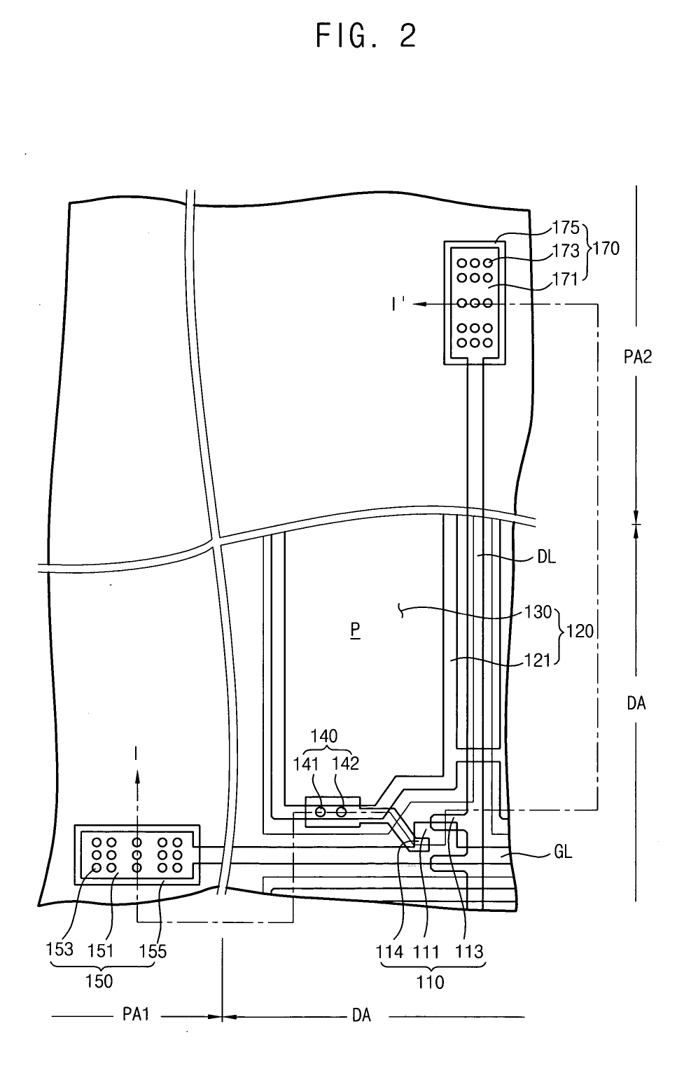

FIG. 2 is an enlarged plan view of the array substrate shown in FIG. 1.

Referring to FIGS. 1 and 2, the array substrate includes the display region DA, the first peripheral region PA1 and the second peripheral region PA2.

A plurality of pixel parts P that are defined by the gate and data lines GL and DL are in the display region DA.

A switching element 110, a storage capacitor 120, a pixel electrode 130 and a contact part 140 are formed in each of the pixel parts P. For example, the switching element 110 includes a thin film transistor (TFT). The storage capacitor 120 is electrically connected to the switching element 110. The pixel electrode 130 is a first electrode of a liquid crystal capacitor.

The switching element 110 includes a gate electrode 111, a source electrode 113, a drain electrode 114 and a channel layer. The gate electrode 111 is electrically connected to one of the gate lines GL. The source electrode 113 is electrically connected to one of the data lines DL. The channel layer is formed between the source and drain electrodes 113 and 114 and on the gate electrode 111.

The storage capacitor 120 includes a common line 121 and a portion of the pixel electrode 130. The common line 121 may be formed from substantially the same layer as the gate lines GL. The common line 121 may have a ring shape to increase an opening rate of each of the pixel parts P. Alternatively, the common line may have various shapes.

The pixel electrode 130 is the first electrode of the liquid crystal capacitor. The pixel electrode 130 is electrically connected to the drain electrode 114 of the switching element 110. A second electrode of the liquid crystal capacitor is formed on an opposite substrate that corresponds to the array substrate. When a voltage difference is applied to the pixel electrode 130 and the common electrode, an electric field is formed between the pixel electrode 130 and the common electrode. Liquid crystal molecules of the liquid crystal layer vary their arrangement in response to the electric field applied thereto, and thus a light transmittance of the liquid crystal layer is changed, thereby displaying an image.

The contact part 140 includes a plurality of contact holes 141 and 142. The drain electrode 114 is partially exposed through the contact holes 141 and 142, and is electrically connected to the pixel electrode 130 through the contact holes 141 and 142. In FIGS. 1 and 2, the number of the contact holes 141 and 142 in the contact part 140 is at least two. An increased number of smaller sized contact holes protects the drain electrode 114, which has a multi-layered structure, from an etchant for etching a passivation layer.

The gate output pads 150 are formed in the first peripheral region PA1. Each of the gate output pads 150 may be a first pad member. Each of the gate output pads 150 includes a first metal pattern 151, a plurality of first contact holes 153 and a first pad pattern 155. The first metal pattern 151 is on an end portion of one of the gate lines GL. The first metal pattern 151 is partially exposed through the first contact holes 153 in the first peripheral region PA1. The first metal pattern 151 is electrically connected to the first pad pattern 155 through the first contact holes 153 in the first peripheral region PA1.

Each of the gate output pads 150 includes the first contact holes 153 in the first peripheral region PA1 to protect the first metal pattern 151, and to increase a contact area between the first metal pattern 151 and the first pad pattern 155.

The data output pads 170 are formed in the second peripheral region PA2. Each of the data output pads 170 may be a second pad member. Each of the data output pads 170 includes a second metal pattern 171, a plurality of contact holes 173 and a second pad pattern 175. The second metal pattern 171 is on an end portion of one of the data lines DL. The second metal pattern 171 is partially exposed through the contact holes 173 in the second peripheral region PA2. The second metal pattern 171 is electrically connected to the second pad pattern 175 through the contact holes 173 in the second peripheral region PA2.

Each of the data output pads 170 includes the contact holes 173 in the second peripheral region PA2 to protect the second metal pattern 171, and to increase a contact area between the second metal pattern 171 and the second pad pattern 175.

Each of the gate and data lines GL and DL has a multi-layered structure. Examples of metals that can be used for each of the gate and data lines GL and DL include aluminum, aluminum alloy, silver, silver alloy, copper, copper alloy, molybdenum, molybdenum alloy, neodymium, neodymium alloy, chromium, tantalum, titanium, etc. These can be used alone or in a combination thereof.

In FIGS. 1 and 2, for example, each of the gate lines GL has a double layered structure including a molybdenum layer and an aluminum layer, and each of the data lines DL has a triple layered structure including a molybdenum layer and an aluminum layer.

Referring to FIGS. 1 and 2, each of the gate output pads 150 is extended from each of the gate lines GL, and the first metal pattern 151 is formed from substantially the same layer as the gate lines GL. Alternatively, each of the gate output pads 150 that are formed from substantially the same layer as the gate lines GL, are not extended from each of the gate lines GL. Each of the data output pads 170 is extended from each of the data lines DL, and the second metal pattern 171 is formed from substantially the same layer as the data lines DL. Alternatively, each of the data output pads 170 that are formed from substantially same layer as the data lines DL are not extended from each of the data lines DL.

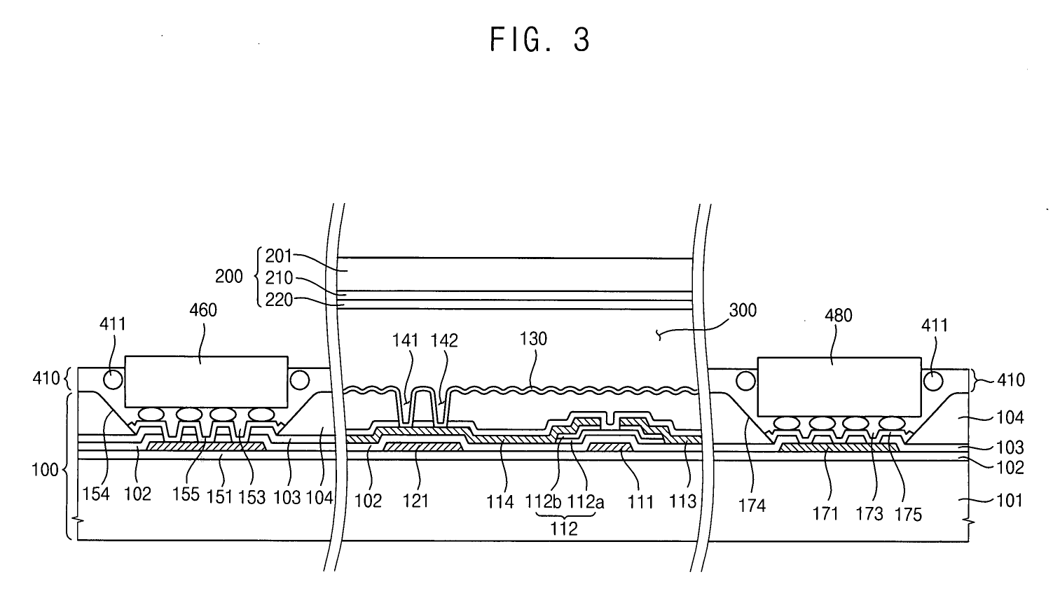

FIG. 3 is a cross-sectional view of a display panel including the array substrate taken along a line I-I′ shown in FIG. 1.

Referring to FIGS. 1 to 3, the display panel includes the array substrate 100, an opposite substrate 200 and a liquid crystal layer 300.

The array substrate 100 includes a first base substrate 101 that is divided into the display region DA, the first peripheral region PA1 and the second peripheral region PA2. The switching element 110 and the storage capacitor 120 are formed in the display region DA.

The switching element 110 includes the gate electrode 111, the source electrode 113, the drain electrode 114 and the channel layer 112. The gate electrode 111 is electrically connected to one of the gate lines GL. The source electrode 113 is electrically connected to one of the data lines DL. The drain electrode 114 is electrically connected to the pixel electrode 130 through the contact part 140. The channel layer 112 is formed on the gate electrode 111 between the source and drain electrodes 113 and 114. The channel layer 112 includes an active layer 112a and an ohmic contact layer 112b.

The contact part 140 includes the contact holes 141 and 142. The drain electrode 114 is partially exposed through the contact holes 141 and 142, and is electrically connected to the pixel electrode 130 through the contact holes 141 and 142.

The gate output pads 150 are formed in the first peripheral region PA1. Each of the gate output pads 150 includes the first metal pattern 151, the first contact holes 153, the first pad pattern 155 and first inclined side surfaces 154.

The first metal pattern 151 is on the end portion of one of the gate lines GL.

The first metal pattern 151 is partially exposed through the first contact holes 153 in the first peripheral region PA1. The first contact holes 153 are formed through a gate insulating layer 102 and a passivation layer 103 that are on the first metal pattern 151.

The first metal pattern 151 is electrically connected to the first pad pattern 155 through the first contact holes 153 in the first peripheral region PA1.

The first inclined side surfaces 154 are on an organic insulating layer 104 to surround the first pad pattern 155. The first inclined side surfaces 154 form an angle of about 0° to about 45° with respect to an upper surface of the organic insulating layer 104. In FIGS. 1 to 3, for example, the first inclined side surfaces 154 form an angle of about 45° with respect to the upper surface of the organic insulating layer 104 so that a contact terminal 460 of the gate driving chip can be mounted on the first pad pattern 155, thereby preventing a misalignment between the contact terminal 460 of the gate driving chip and the first pad pattern 155. Therefore, contact characteristics between the contact terminal 460 of the gate driving chip and the first pad pattern 155 are improved.

An anisotropy conductive film (ACF) 410 is interposed between the contact terminal 460 of the gate driving chip and the first pad pattern 155, and the anisotropy conductive film 410 is pressed so that the contact terminal 460 of the gate driving chip is electrically connected to the first pad pattern 155 through the anisotropy conductive film 410. In particular, the anisotropy conductive film 410 includes a plurality of conductive particles 411 so that the contact terminal 460 of the gate driving chip is electrically connected to the first pad pattern 155 through the conductive particles 411.

The data output pads 170 are formed in the second peripheral region PA2. Each of the data output pads 170 includes the second metal pattern 171, the second contact holes 173, the second pad pattern 175 and second inclined side surfaces 174.

The second metal pattern 171 is on the end portion of one of the data lines DL.

The second metal pattern 171 is partially exposed through the second contact holes 173 in the second peripheral region PA2. The second contact holes 173 are formed through the passivation layer 103 that is on the second metal pattern 171.

The second metal pattern 171 is electrically connected to the second pad pattern 175 through the second contact holes 173 in the second peripheral region PA2.

The second inclined side surfaces 174 are on the organic insulating layer 104 to surround the second pad pattern 175. The second inclined side surfaces 174 form an angle of about 0° to about 45° with respect to the upper surface of the organic insulating layer 104. In FIGS. 1 to 3, for example, the second inclined side surfaces 174 form an angle of about 45° with respect to the upper surface of the organic insulating layer 104 so that a contact terminal 480 of the data driving chip can be mounted on the second pad pattern 175, thereby preventing a misalignment between the contact terminal 480 of the data driving chip and the second pad pattern 175. Therefore, contact characteristics between the contact terminal 480 of the data driving chip and the second pad pattern 175 are improved.

The anisotropy conductive film (ACF) 410 is interposed between the contact terminal 480 of the data driving chip and the second pad pattern 175, and the anisotropy conductive film 410 is pressed so that the contact terminal 480 of the data driving chip is electrically connected to the second pad pattern 175 through the anisotropy conductive film 410. In particular, the anisotropy conductive film 410 includes the conductive particles 411 so that the contact terminal 480 of the data driving chip is electrically connected to the second pad pattern 175 through the conductive particles 411.

The opposite substrate 200 includes a second base substrate 201, a color filter layer 210 and the common electrode 220.

The color filter layer 210 includes a red color filter, a green color filter and a blue color filter. The red, green and blue color filters correspond to the pixel parts P, respectively. The common electrode 220 corresponds to the pixel electrode 130. A common voltage is applied to the common electrode 220. An overcoating layer (not shown) may be formed on the common electrode to protect the common electrode layer 220 and planarize the opposite substrate 200.

Liquid crystal molecules of the liquid crystal layer 300 vary their arrangement in response to the electric field applied between the pixel electrode 130 of the array substrate 100 and the common electrode 220 of the opposite substrate 200.

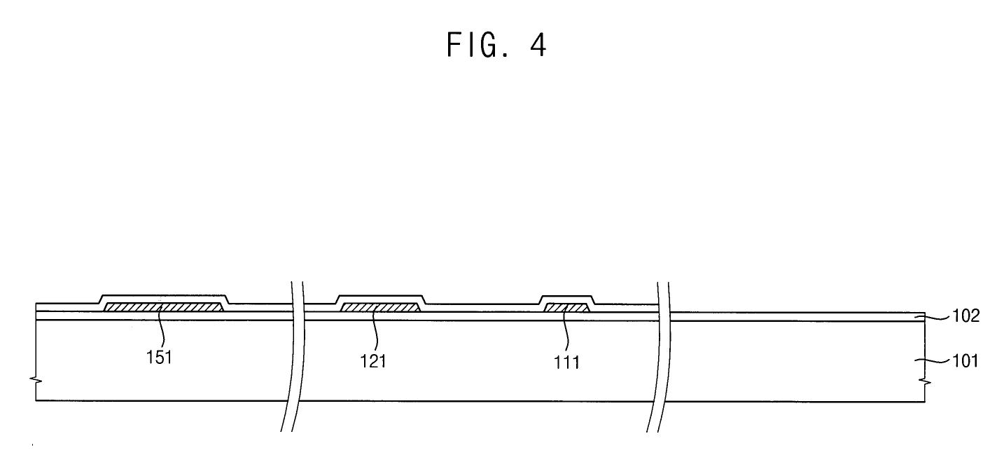

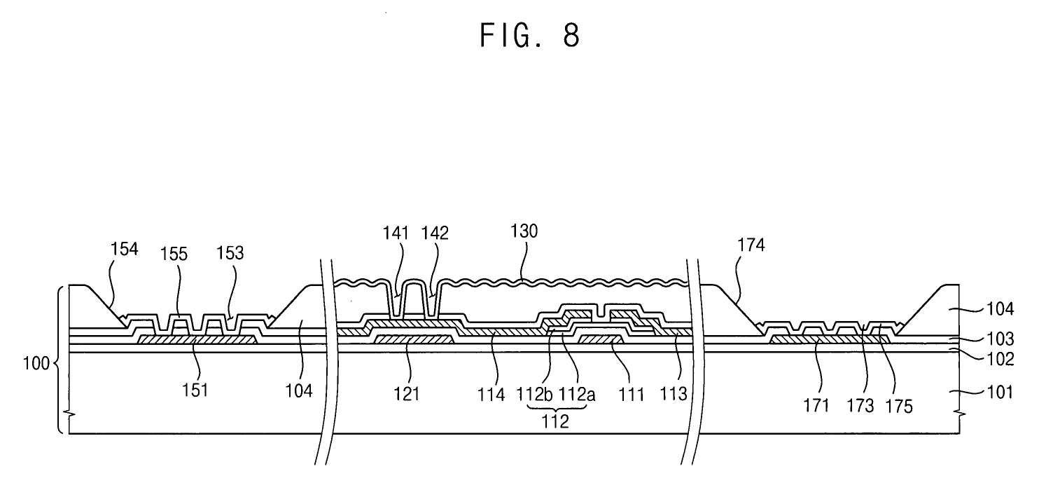

FIGS. 4 to 8 are cross-sectional views of an array substrate for showing a method of manufacturing the array substrate shown in FIG. 3.

Referring to FIGS. 1 to 4, a gate metal layer is formed on the first base substrate 101. The gate metal layer may have a multi-layered structure including molybdenum. The first base substrate 101 includes an insulating material. Examples of the insulating material that can be used for the first base substrate 101 include glass, ceramic, etc. The gate metal layer is patterned through a photolithography process to form the gate lines GL, the gate electrode 111, the common line 121 and the first metal pattern 151 of the gate output pads 150. The gate input pads 160, the data input pads 180 and the FPC pads 190 may also be formed from the gate metal layer through the photolithography process.

The gate insulating layer 102 is formed on the first base substrate 101 having the gate lines GL, the gate electrode 111, the common line 121, the first metal pattern 151 of the gate output pads 150, the gate input pads 160, the data input pads 180 and the FPC pads 190 through a chemical vapor deposition (CVD) method. The gate insulating layer 102 includes an insulating material. Examples of the insulating material that can be used for the gate insulating layer 102 include silicon nitride, silicon oxide, etc.

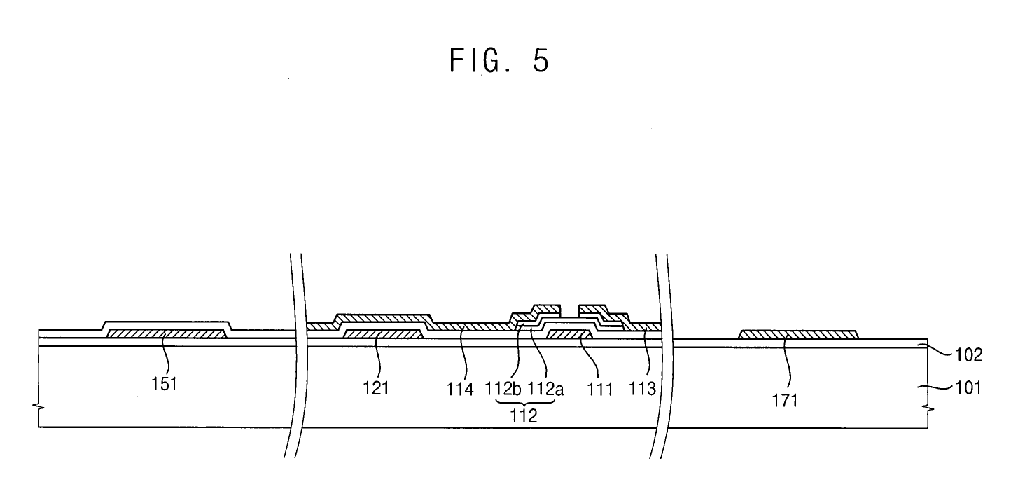

Referring to FIGS. 2 and 5, the active layer 112a and the ohmic contact layer 112b are formed on the gate insulating layer 102. The active layer 112a and the ohmic contact layer 112b are formed through a photolithography process. The active layer 112a and the ohmic contact layer 112b are located over the gate electrode 111 of the switching element 110.

Particularly, an amorphous silicon layer is deposited on the gate insulating layer 102 through a chemical vapor deposition (CVD) method, and impurities are implanted on an upper portion of the amorphous silicon layer to form an N+ amorphous silicon layer. The amorphous silicon layer and the N+ amorphous silicon layer are patterned through the photolithography process to form the active layer 112a and the ohmic contact layer 112b on the gate insulating layer 102 corresponding to the gate electrode 111.

A data metal layer is formed on the gate insulating layer 102 having the active layer 112a and the ohmic contact layer 112b. The data metal layer may have a multi-layered structure including molybdenum. The data metal layer is patterned through a photolithography process to form the data lines DL, the source electrode 113, the drain electrode 114 and the second metal pattern 171 of the data output pads 170.

The ohmic contact layer 112b is partially etched using the source and drain electrodes 113 and 114 as an etching mask to form the channel region of the switching element 110.

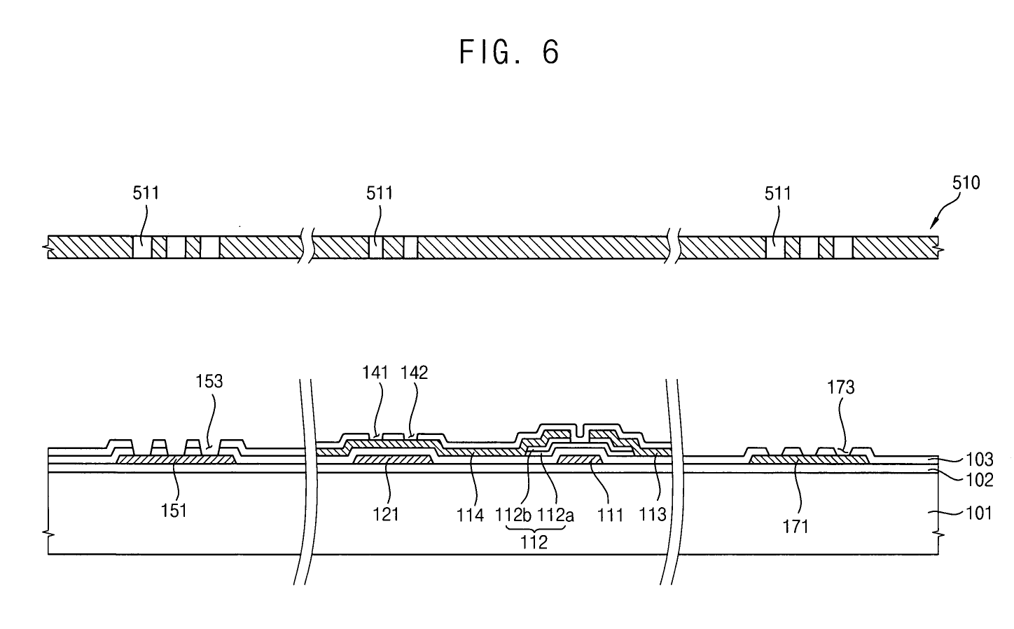

Referring to FIGS. 2 and 6, the passivation layer 103 is formed on the gate insulating layer 102 having the active layer 112a, the ohmic contact layer 112b, the data lines DL, the source electrode 113, the drain electrode 114 and the second metal pattern 171.

A first mask 510 is aligned over the passivation layer 103. The first mask 510 includes a pattern with a plurality of openings corresponding to the contact holes 141 and 142 of the contact part 140, the first contact holes 153 of the gate output pads 150 and the second contact holes 173 of the data output pads 170.

The gate insulating layer 102 and the passivation layer 103 are partially etched through a dry etching process so that the gate metal layer and the data metal layer are partially exposed.

In particular, the gate insulating layer 102 and the passivation layer 103 are partially etched through a dry etching process to form the contact holes 141 and 141 of the contact part 140, the first contact holes 153 of the gate output pads 150 and the second contact holes 173 of the data output pads 170. The drain electrode 114 is partially exposed through the contact holes 141 and 142 of the contact part 140. The first metal pattern 151 of each of the gate output pads 150 is partially exposed through the first contact holes 153. The second metal pattern 171 of each of the data output pads 170 is partially exposed through the second contact holes 173.

Sizes of the contact holes 141 and 142, the first contact holes 153 and the second contact holes 173 are decreased, and the number of the contact holes 141, 142, 153 and 173 are increased, so that the molybdenum of the gate and data metal layers is not etched through the dry etching process.

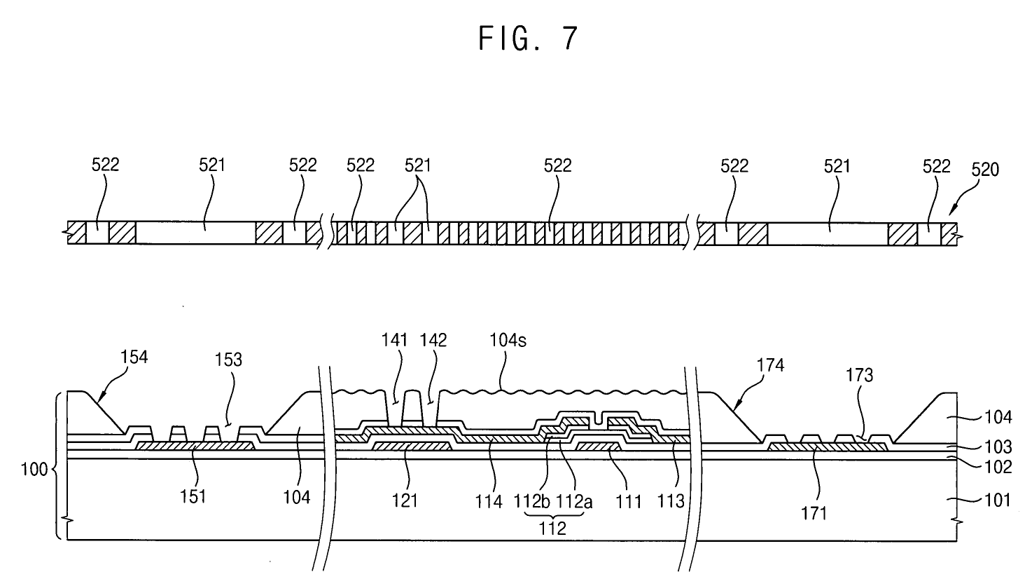

Referring to FIGS. 2 and 7, a photoresist film is coated on the passivation layer 103 at a thickness of about 2 μm to about 4 μm through a spin coating method. The photoresist film may include a reflective material.

A second mask 520 is aligned over the organic insulating layer 104. The second mask 520 includes first openings 521 and second openings 522. The first openings 521 correspond to the contact holes 141, 142, 153 and 173, the first metal pattern 153 and the second metal pattern 173. The second openings 522 correspond to peripheral regions of the first metal pattern 153, the second metal pattern 173 and the pixel parts P, respectively. For example, the peripheral regions may be outside of the first metal pattern 153, the second metal pattern 173 and the pixel parts P. Alternatively, the peripheral regions may overlap with the first metal pattern 153, the second metal pattern 173 and the pixel parts P.

The photoresist film is exposed through the second mask 520. Portions of the photoresist film corresponding to the contact holes 141, 142, 153 and 173, the first metal pattern 153 and the second metal pattern 173 are fully exposed through the first openings 521. Portions of the photoresist film corresponding to the peripheral regions of the first metal pattern 153, the second metal pattern 173 and the pixel parts P are partially exposed through the second openings 522. For example, the second openings 522 may include slits, translucent portions, etc.

The exposed photoresist film is then developed. The parts of the photoresist film corresponding to the contact holes 141, 142, 153 and 173, the first metal pattern 153 and the second metal pattern 173 are fully removed through the development process.

The parts of the photoresist film corresponding to the peripheral regions of the first metal pattern 153, the second metal pattern 173 and the pixel parts P are partially removed to form the first inclined side surfaces 154 and the second inclined side surfaces 174 on each of the gate output pads 150 and each of the data output pads 170, thereby forming the organic insulating layer 104. The first inclined side surfaces 154 form an angle of about 0° to about 45° with respect to an upper surface of the organic insulating layer 104. For example, the first inclined side surfaces 154 form an angle of about 45° with respect to the upper surface of the organic insulating layer 104. In addition, an embossed pattern 104s having convex and concave portions may be formed on each of the pixel parts P through the exposure process.

Referring to FIGS. 1, 2 and 8, a pixel electrode layer is formed on the organic insulating layer 104. The pixel electrode layer is patterned through a photolithography process to form the pixel electrode 130 of each of the pixel parts P, the first pad pattern 155 and the second pad pattern 175. In addition, pad patterns of the gate input pads 160, the data input pads 180 and the FPC pads 190 are formed from the pixel electrode layer through the photolithography process.

The pixel electrode layer includes a transparent conductive material. Examples of the transparent conductive material that can be used for the pixel electrode layer include indium tin oxide (ITO), tin oxide (TO), indium zinc oxide (IZO), zinc oxide (ZO), indium tin-zinc oxide (ITZO), etc. These can be used alone or in a combination thereof.

A reflection electrode (not shown) may be formed on the pixel electrode 130. The reflection electrode includes a highly reflective material. Examples of the highly reflective material that can be used for the reflection electrode include aluminum, nickel, chromium, silver, etc. A reflective layer having the highly reflective material is deposited on the pixel electrode 130, and then partially etched to form the reflection electrode. Alternatively, the reflection electrode may be formed on the embossed pattern 104s to increase a reflectivity of the reflection electrode.

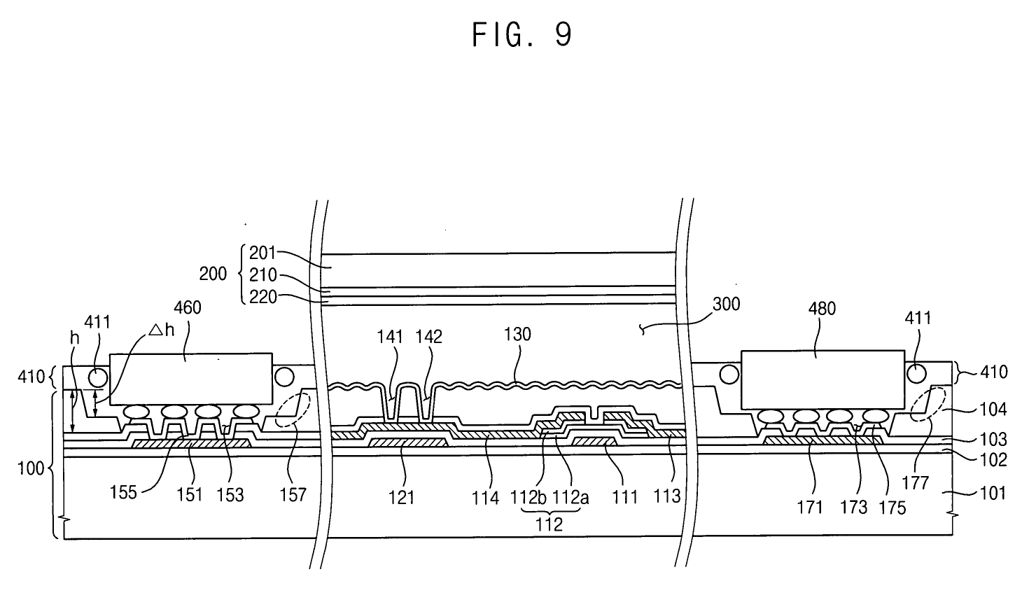

FIG. 9 is a cross-sectional view showing a display panel in accordance with an embodiment of the present invention. The display panel of FIG. 9 is substantially the same as the display panel in FIG. 3 with some exceptions, for example, stepped side surfaces 155 and 157.

Referring to FIG. 9, the display panel includes the array substrate 100, an opposite substrate 200 and a liquid crystal layer 300.

The array substrate 100 includes a first base substrate 101 that is divided into the display region DA, the first peripheral region PA1 and the second peripheral region PA2. A switching element 110 and a storage capacitor 120 are formed in the display region DA.

The switching element 110 includes a gate electrode 111, a source electrode 113, a drain electrode 114 and a channel layer 112. The drain electrode 114 is electrically connected to a pixel electrode 130 through a contact part 140.

The contact part 140 includes a plurality of contact holes 141 and 142. The drain electrode 114 is partially exposed through the contact holes 141 and 142, and is electrically connected to the pixel electrode 130 through the contact holes 141 and 142.

A plurality of gate output pads 150 are formed in the first peripheral region PA1. Each of the gate output pads 150 includes a first metal pattern 151, a plurality of first contact holes 153, a first pad pattern 155 and first stepped side surfaces 157.

The first metal pattern 151 is on an end portion of one of the gate lines GL.

The first metal pattern 151 is partially exposed through the first contact holes 153 in the first peripheral region PA1. The first contact holes 153 are formed through a gate insulating layer 102 and a passivation layer 103 that are on the first metal pattern 151.

The first metal pattern 151 is electrically connected to the first pad pattern 155 through the first contact holes 153 in the first peripheral region PA1.

The first stepped side surfaces 157 are on an organic insulating layer 104 to surround the first pad pattern 155. A height Δh of the first stepped side surfaces 157 is greater than zero and smaller than a height h of the organic insulating layer 104. For example, when the height h of the organic insulating layer 104 is about 4 μm, the height Δh of the first stepped side surfaces 157 may be about 2.1 μm to about 2.4 μm.

A contact terminal 460 of a gate driving chip can be mounted on the first pad pattern 155 to prevent a misalignment between the contact terminal 460 of the gate driving chip and the first pad pattern 155. Therefore, contact characteristics between the contact terminal 460 of the gate driving chip and the first pad pattern 155 are improved.

An anisotropy conductive film (ACF) 410 is interposed between the contact terminal 460 of the gate driving chip and the first pad pattern 155, and the anisotropy conductive film 410 is pressed so that the contact terminal 460 of the gate driving chip is electrically connected to the first pad pattern 155 through the anisotropy conductive film 410. In particular, the anisotropy conductive film 410 includes a plurality of conductive particles 411 so that the contact terminal 460 of the gate driving chip is electrically connected to the first pad pattern 155 through the conductive particles 411.

A plurality of data output pads 170 are formed in the second peripheral region PA2. Each of the data output pads 170 includes a second metal pattern 171, a plurality of second contact holes 173, a second pad pattern 175 and second stepped side surfaces 177.

The second metal pattern 171 is on an end portion of one of the data lines DL.

The second metal pattern 171 is partially exposed through the second contact holes 173 in the second peripheral region PA2. The second contact holes 173 are formed through the passivation layer 103 that is on the second metal pattern 171.

The second metal pattern 171 is electrically connected to the second pad pattern 175 through the second contact holes 173 in the second peripheral region PA2.

The second stepped side surfaces 177 are on the organic insulating layer 104 to surround the second pad pattern 175.

A height Δh of the second stepped side surfaces 177 is greater than zero and smaller than the height h of the organic insulating layer 104. For example, when the height h of the organic insulating layer 104 is about 4 μm, the height Δh of the second stepped side surfaces 177 may be about 2.1 μm to about 2.4 μm.

A contact terminal 480 of a data driving chip can be mounted on the second pad pattern 175 to prevent a misalignment between the contact terminal 480 of the data driving chip and the second pad pattern 175. Therefore, contact characteristics between the contact terminal 480 of the data driving chip and the second pad pattern 175 are improved.

The anisotropy conductive film (ACF) 410 is interposed between the contact terminal 480 of the data driving chip and the second pad pattern 175, and the anisotropy conductive film 410 is pressed so that the contact terminal 480 of the data driving chip is electrically connected to the second pad pattern 175 through the anisotropy conductive film 410. In particular, the anisotropy conductive film 410 includes the conductive particles 411 so that the contact terminal 480 of the data driving chip is electrically connected to the second pad pattern 175 through the conductive particles 411.

The opposite substrate 200 includes a second base substrate 201, a color filter layer 210 and a common electrode 220.

The color filter layer 210 includes a red color filter, a green color filter and a blue color filter. The red, green and blue color filters correspond to the pixel parts P, respectively. The common electrode 220 corresponds to the pixel electrode 130. A common voltage is applied to the common electrode 220. An overcoating layer (not shown) may be formed on the common electrode to protect the common electrode 220 and to planarize the opposite substrate 200.

Liquid crystal molecules of the liquid crystal layer 300 vary their arrangement in response to the electric field applied between the pixel electrode 130 of the array substrate 100 and the common electrode 220 of the opposite substrate 200.

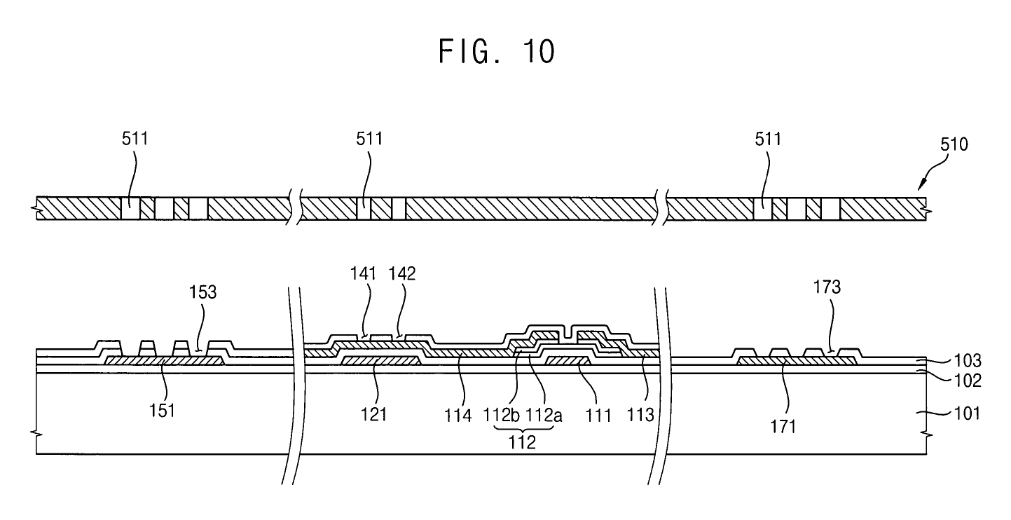

FIGS. 10 to 13 are cross-sectional views of an array substrate for showing a method of manufacturing an array substrate shown in FIG. 9.

Referring to FIG. 10, the contact holes 141, 142, 153 and 173 are formed through a dry etching process using a first mask 510.

In particular, sizes of the contact holes 141, 142, 153 and 173 are decreased, and the number of the contact holes 141, 142, 153 and 173 are increased, so that the molybdenum of the gate and data metal layers is not etched through the dry etching process.

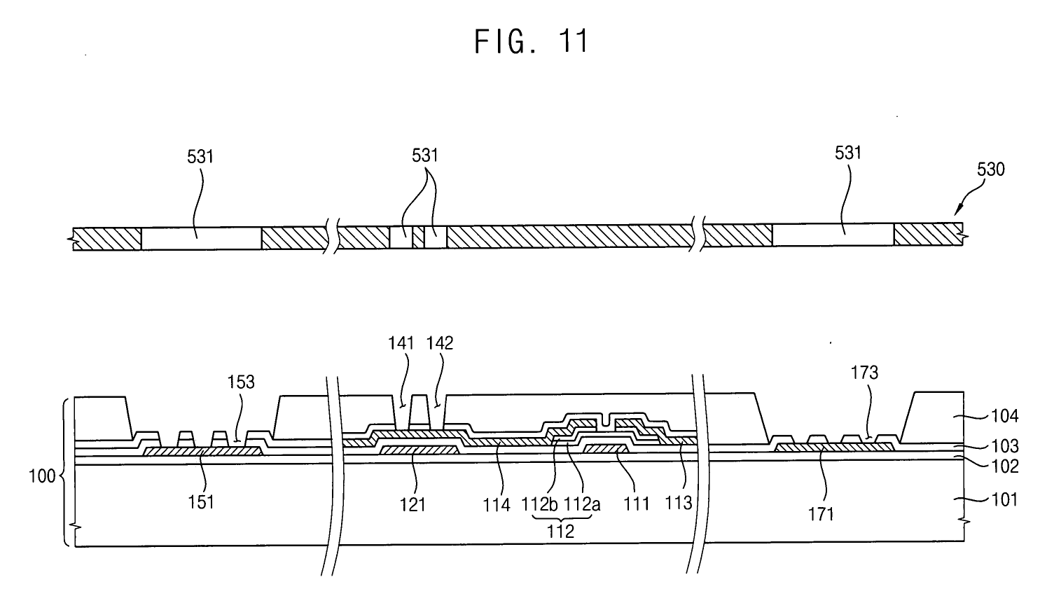

Referring to FIGS. 9 and 11, a photoresist film is coated on the passivation layer 103 at a thickness of about 2 μm to about 4 μm through a spin coating method. The photoresist film may include a reflective material.

A third mask 530 is aligned over the organic insulating layer 104.

The third mask 530 includes openings 531 corresponding to the contact holes 141 and 142 of the contact part 140, the first metal pattern 151 and the second metal pattern 171.

The photoresist film is exposed through the third mask 530. Portions of the photoresist film corresponding to the contact holes 141 and 142 of the contact part 140, the first metal pattern 151 and the second metal pattern 171 are exposed through the first openings 521. The exposed photoresist film is then developed so that the portions of the photoresist film corresponding to the contact holes 141 and 142 of the contact part 140, the first metal pattern 151 and the second metal pattern 171 are removed through the development process.

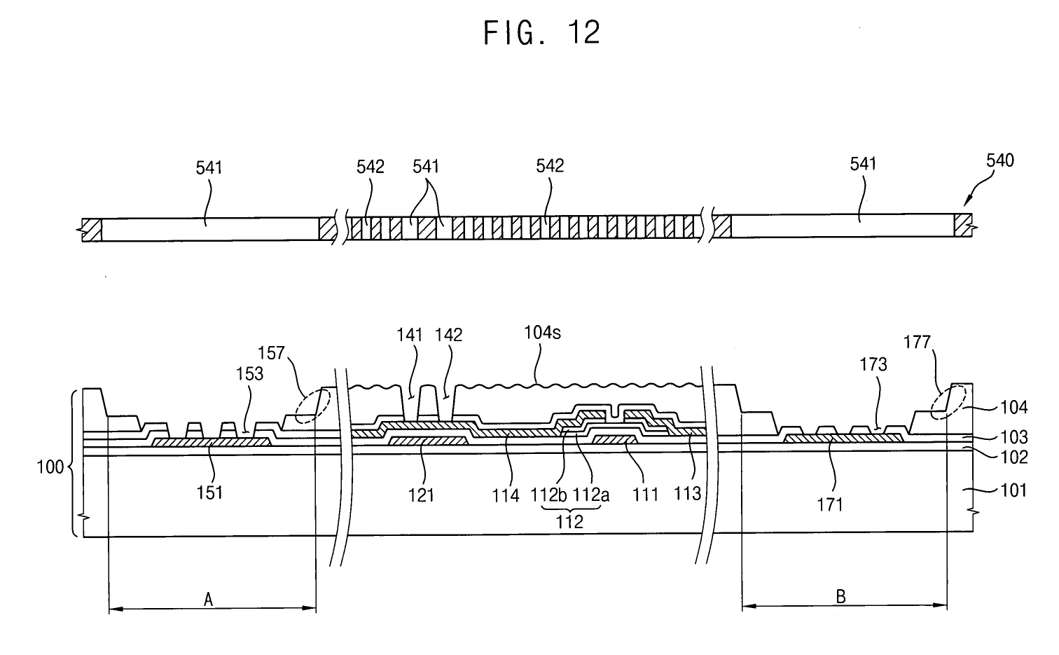

Referring to FIGS. 9 and 12, a fourth mask 540 is aligned over the developed photoresist film.

The fourth mask 540 includes first openings 541 and second openings 542. The first openings 541 correspond to a peripheral portion A of the first metal pattern 151, a peripheral portion B of the second metal pattern 171 and the contact holes 141 and 142. The second openings 542 correspond to the pixel parts P.

The photoresist film is exposed through the fourth mask 540. Portions of the photoresist film corresponding to the peripheral portion A of the first metal pattern 151, the peripheral portion B of the second metal pattern 171 and the contact holes 141 and 142 are fully exposed through the first openings 541. Portions of the photoresist film corresponding to each of the pixel patterns P are partially exposed through the second openings 542.

The exposed photoresist film is then developed so that the portions of the photoresist film corresponding to the peripheral portion A of the first metal pattern 151, the peripheral portion B of the second metal pattern 171 and the contact holes 141 and 142 are fully removed, and the portions of the photoresist film corresponding to each of the pixel patterns P are partially removed through the development process to form the organic insulating layer 104. The organic insulating layer 104 includes the first stepped portions 157 corresponding to the peripheral portion A of the first metal pattern 151 and the second stepped portions 177 of the peripheral portion B of the second metal pattern 171. The height Δh of the first stepped side surfaces 157 is greater than zero and smaller than the height h of the organic insulating layer 104. For example, when the height h of the organic insulating layer 104 is about 4 μm, the height Δh of the first stepped side surfaces 157 may be about 2.1 μm to about 2.4 μm.

Therefore, the first and second stepped side surfaces 157 and 177 are formed on each of the gate output pads 150 and each of the data output pads 170, respectively.

In addition, an embossed pattern 104s having convex and concave portions may be formed on each of the pixel parts P through the exposure process.

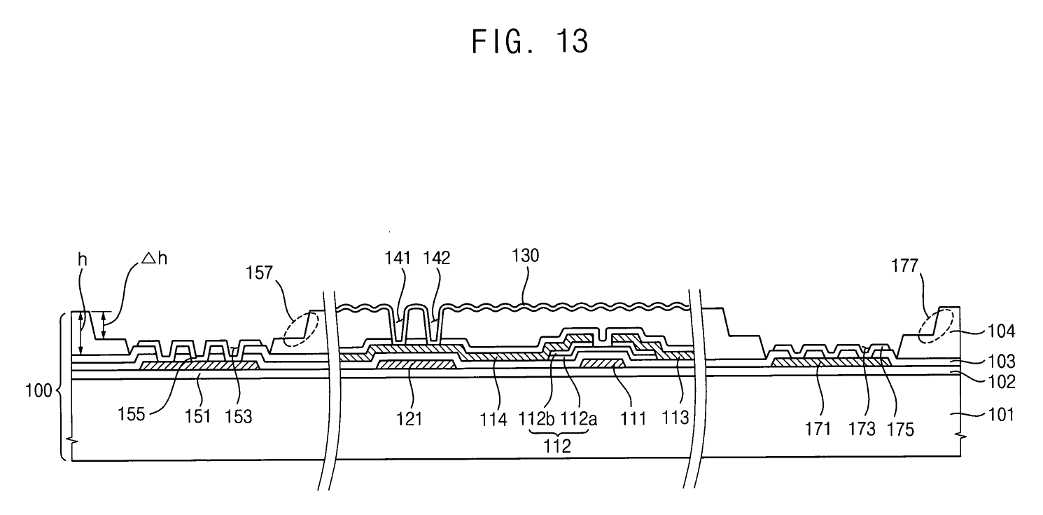

Referring to FIGS. 9 and 13, a pixel electrode layer is formed on the organic insulating layer 104. The pixel electrode layer is patterned through a photolithography process to form the pixel electrode 130 of each of the pixel parts P, the first pad pattern 155 and the second pad pattern 175.

The pixel electrode layer includes a transparent conductive material. Examples of the transparent conductive material that can be used for the pixel electrode layer include indium tin oxide (ITO), tin oxide (TO), indium zinc oxide (IZO), zinc oxide (ZO), indium tin-zinc oxide (ITZO), etc. These can be used alone or in a combination thereof.

A reflection electrode (not shown) may be formed on the pixel electrode 130. The reflection electrode includes a highly reflective material. Examples of the highly reflective material that can be used for the reflection electrode include aluminum, nickel, chromium, silver, etc. A reflective layer having the highly reflective material is deposited on the pixel electrode 130, and then partially etched to form the reflection electrode. Alternatively, the reflection electrode may be formed on the embossed pattern 104s to increase a reflectivity of the reflection electrode.

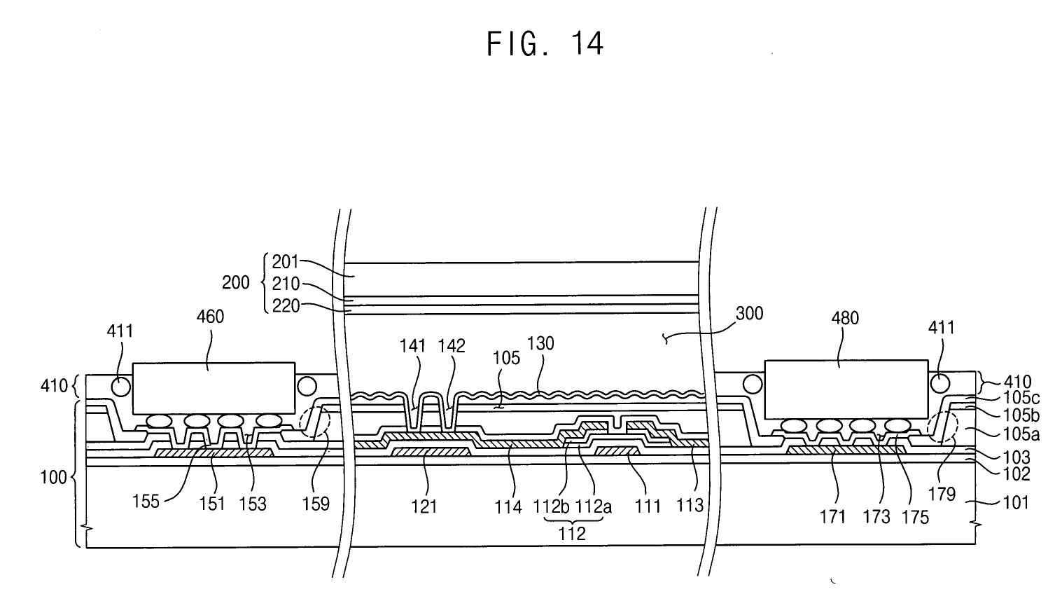

FIG. 14 is a cross-sectional view showing a display panel in accordance with an embodiment of the present invention. The display panel of FIG. 14 is substantially the same as the display panel in FIG. 3 with some exceptions. Referring to FIG. 14, the display panel includes the array substrate 100, an opposite substrate 200 and a liquid crystal layer 300.

The array substrate 100 includes a first base substrate 101 that is divided into the display region DA, the first peripheral region PA1 and the second peripheral region PA2. A switching element 110 and a storage capacitor 120 are formed in the display region DA.

The switching element 110 includes a gate electrode 111, a source electrode 113, a drain electrode 114 and a channel layer 112. The drain electrode 114 is electrically connected to a pixel electrode 130 through a contact part 140.

The contact part 140 includes a plurality of contact holes 141 and 142 formed in a multi-layered organic insulating layer 105. The drain electrode 114 is partially exposed through the contact holes 141 and 142, and is electrically connected to the pixel electrode 130 through the contact holes 141 and 142.

The multi-layered organic insulating layer 105 includes a first organic insulating layer 105a, a second organic insulating layer 105b and a third organic insulating layer 105c. The first, second and third organic insulating layers 105a, 105b and 105c may have various refractive indexes. The number of the organic insulating layers of the multi-layered organic insulating layer may vary.

A plurality of gate output pads 150 are formed in the first peripheral region PA1. Each of the gate output pads 150 includes a first metal pattern 151, a plurality of first contact holes 153, a first pad pattern 155 and first stepped side surfaces 159.

The first metal pattern 151 is on an end portion of one of the gate lines GL.

The first metal pattern 151 is partially exposed through the first contact holes 153 in the first peripheral region PA1. The first contact holes 153 are formed through a gate insulating layer 102 and a passivation layer 103 that are on the first metal pattern 151.

The first metal pattern 151 is electrically connected to the first pad pattern 155 through the first contact holes 153 in the first peripheral region PA1.

The first stepped side surfaces 159 are on the multi-layered organic insulating layer 105 to surround the first pad pattern 155. For example, as shown in FIG. 14, the first stepped side surfaces 159 may include the third organic insulating layer 105c formed on the first and second organic insulating layers 105a and 105b. For example, when the height h of the multi-layered organic insulating layer 105, including layers 105a, 105b and 105c, is about 4 μm, the height Δh of the first stepped side surfaces 159 may be about 2.1 μm to about 2.4 μm.

A contact terminal 460 of a gate driving chip can be mounted on the first pad pattern 155 adjacent the first stepped surfaces 159 to prevent a misalignment between the contact terminal 460 of the gate driving chip and the first pad pattern 155. Therefore, contact characteristics between the contact terminal 460 of the gate driving chip and the first pad pattern 155 are improved.

An anisotropy conductive film (ACF) 410 is interposed between the contact terminal 460 of the gate driving chip and the first pad pattern 155, and the anisotropy conductive film 410 is pressed so that the contact terminal 460 of the gate driving chip is electrically connected to the first pad pattern 155 through the anisotropy conductive film 410. In particular, the anisotropy conductive film 410 includes a plurality of conductive particles 411 so that the contact terminal 460 of the gate driving chip is electrically connected to the first pad pattern 155 through the conductive particles 411.

A plurality of data output pads 170 are formed in the second peripheral region PA2. Each of the data output pads 170 includes a second metal pattern 171, a plurality of second contact holes 173, a second pad pattern 175 and second stepped side surfaces 179.

The second metal pattern 171 is on an end portion of one of the data lines DL.

The second metal pattern 171 is partially exposed through the second contact holes 173 in the second peripheral region PA2. The second contact holes 173 are formed through the passivation layer 103 that is on the second metal pattern 171.

The second metal pattern 171 is electrically connected to the second pad pattern 175 through the second contact holes 173 in the second peripheral region PA2.

The second stepped side surfaces 179 are on the multi-layered organic insulating layer 105 to surround the second pad pattern 175. For example, as shown in FIG. 14, the second stepped side surfaces 179 may include the third organic insulating layer 105c formed on the first and second organic insulating layers 105a and 105b. For example, when the height h of the multi-layered organic insulating layer 105, including layers 105a, 105b and 105c, is about 4 μm, the height Δh of the second stepped side surfaces 179 may be about 2.1 μm to about 2.4 μm.

A contact terminal 480 of a data driving chip can be mounted on the second pad pattern 175 to prevent a misalignment between the contact terminal 480 of the data driving chip and the second pad pattern 175. Therefore, contact characteristics between the contact terminal 480 of the data driving chip and the second pad pattern 175 are improved.

The anisotropy conductive film (ACF) 410 is interposed between the contact terminal 480 of the data driving chip and the second pad pattern 175, and the anisotropy conductive film 410 is pressed so that the contact terminal 480 of the data driving chip is electrically connected to the second pad pattern 175 through the anisotropy conductive film 410. In particular, the anisotropy conductive film 410 includes the conductive particles 411 so that the contact terminal 480 of the data driving chip is electrically connected to the second pad pattern 175 through the conductive particles 411.

The opposite substrate 200 includes a second base substrate 201, a color filter layer 210 and a common electrode 220.

The color filter layer 210 includes a red color filter, a green color filter and a blue color filter. The red, green and blue color filters correspond to the pixel parts P, respectively. The common electrode 220 corresponds to the pixel electrode 130. A common voltage is applied to the common electrode 220. An overcoating layer (not shown) may be formed on the common electrode to protect the common electrode 220 and to planarize the opposite substrate 200.

Liquid crystal molecules of the liquid crystal layer 300 vary their arrangement in response to the electric field applied between the pixel electrode 130 of the array substrate 100 and the common electrode 220 of the opposite substrate 200.

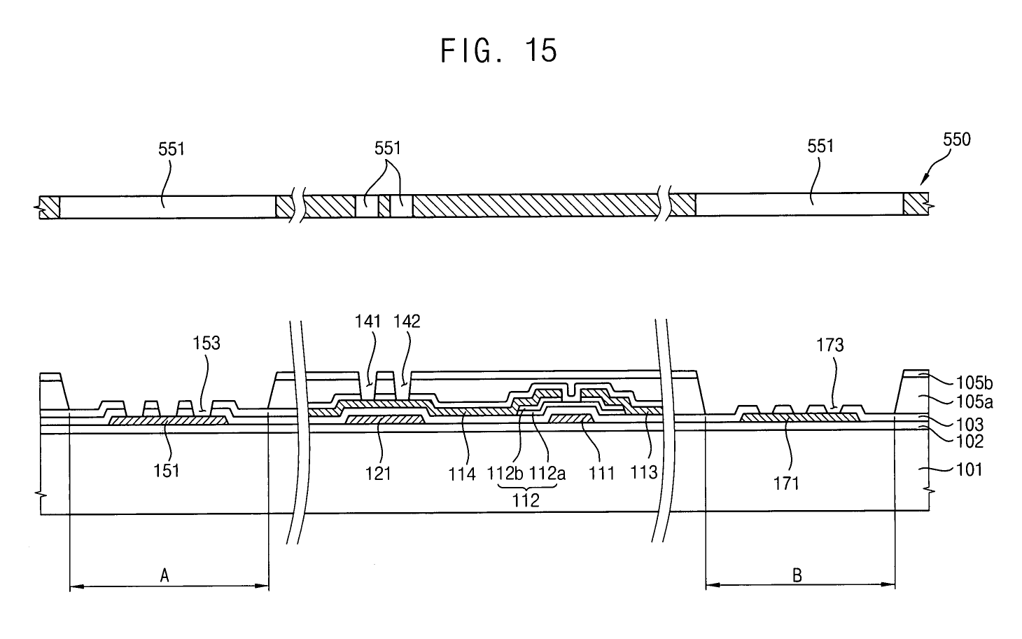

FIGS. 15 to 17 are cross-sectional views of an array substrate for showing a method of manufacturing an array substrate shown in FIG. 14.

Referring to FIG. 15, the contact holes 141, 142, 153 and 173 are formed through a dry etching process using a first mask 510.

In particular, sizes of the contact holes 141, 142, 153 and 173 are decreased, and the number of the contact holes 141, 142, 153 and 173 are increased, so that the molybdenum of the gate and data metal layers is not etched through the dry etching process.

A first primitive organic insulating layer is formed on the passivation layer 103 having the contact holes 141, 142, 153 and 173, and a second primitive organic insulating layer is formed on the first primitive organic insulating layer. The first and second primitive organic insulating layers have different refractive indexes from each other. When the array substrate includes the multi-layered organic insulating layer 105, a reflective index of the array substrate may be increased.

When a wavelength of a light is about λ, a thickness of one of the organic insulating layers 105a, 105b and 105c may be about λn/2, wherein n is a natural number.

For example, when a refractive index of m-th organic insulating layer and a refractive index of (m+1)-th organic insulating layer are about Nm and Nm+1, respectively, a thickness of the m-th organic insulating layer is about Nm/Nm+1×nλ/2. When the m-th organic insulating layer is an outermost organic insulating layer, the thickness of the m-th organic insulating layer is about Nm/Nair×nλ/2, wherein Nair is a refractive index of air.

A fifth mask 550 is aligned over the first base substrate 101 having the first and second primitive organic insulating layers.

The fifth mask 550 includes openings 551. The openings 551 correspond to a peripheral portion A of the first metal pattern 151, a peripheral portion B of the second metal pattern 171 and the contact holes 141 and 142.

The first and second primitive organic insulating layers are exposed through the fifth mask 550. Portions of the first and second primitive organic insulating layer corresponding to the peripheral portion A of the first metal pattern 151, the peripheral portion B of the second metal pattern 171 and the contact holes 141 and 142 are fully exposed through the first openings 541. The exposed first and second primitive organic insulating layers are then developed so that the portions of the first and second primitive organic insulating layer corresponding to the peripheral portion A of the first metal pattern 151, the peripheral portion B of the second metal pattern 171 and the contact holes 141 and 142 are fully removed.

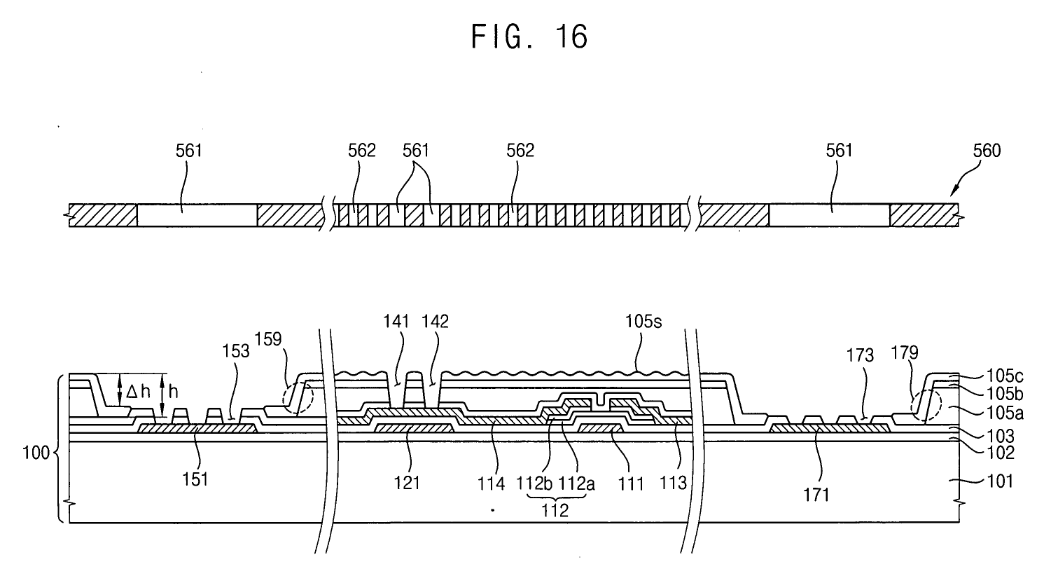

Referring to FIGS. 14 and 16, the third organic insulating layer 105c is formed on the second organic insulating layer 105a and 105b. For example, the third organic insulating layer 105c may have substantially the same refractive index as the first organic insulating layer 105a. Alternatively, the third organic insulating layer 105c may have a different refractive index from the first organic insulating layer 105a.

Therefore, the multi-layered organic insulating layer 105 having the first, second and third organic insulating layers 105a, 105b and 105c is formed on the array substrate.

A sixth mask 560 is aligned over the third organic insulating layer 105c.

The sixth mask 560 includes first openings 561 and second openings 562. The first openings 561 correspond to the first metal pattern 151, the second metal pattern 171 and the contact holes 141 and 142 of the contact part 140. The second openings 562 correspond to the pixel parts P.

Portions of the third organic insulating layer 105c corresponding to the first openings 561 are exposed and developed so that the first metal pattern 151, the second metal pattern 171 and the drain electrode 114 are partially exposed. For example, when a height h of the multi layered organic insulating layer 105 is about 4 μm, the height Δh of stepped portions of the first and second stepped side surfaces 159 and 179 may be about 2.1 μm to about 2.4 μm.

Therefore, the first and second stepped side surfaces 159 and 179 are formed on each of the gate output pads 150 and each of the data output pads 170.

In addition, an embossed pattern 105s having convex and concave portions may be formed on each of the pixel parts P through the exposure and development processes.

Referring to FIGS. 15 to 17, the first and second organic insulating layers 105a and 105b are partially removed to form the stepped portions of the first and second stepped side surfaces 159 and 179.

Alternatively, after the first, second and third primitive organic insulating layers are formed, the second and third primitive organic insulating layers may be partially removed to form the stepped portions of the first and second stepped side surfaces.

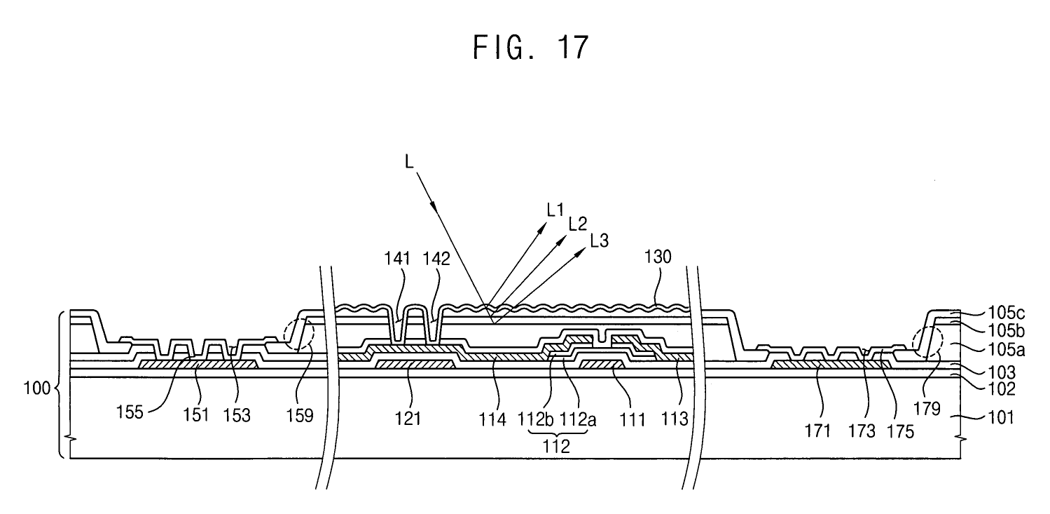

Referring to FIGS. 14 and 17, a pixel electrode layer is formed on the third organic insulating layer 105c. The pixel electrode layer is partially removed through a photolithography process to form the pixel electrode 130 of each of the pixel parts P, the first pad pattern 155 and the second pad pattern 175.

The pixel electrode layer includes a transparent conductive material. Examples of the transparent conductive material that can be used for the pixel electrode layer include indium tin oxide (ITO), tin oxide (TO), indium zinc oxide (IZO), zinc oxide (ZO), indium tin-zinc oxide (ITZO), etc. These can be used alone or in a combination thereof.

A reflection electrode (not shown) may be formed on the pixel electrode 130. The reflection electrode includes a highly reflective material. Examples of the highly reflective material that can be used for the reflection electrode include aluminum, nickel, chromium, silver, etc. A reflective layer having the highly reflective material is deposited on the pixel electrode 130, and then partially etched to form the reflection electrode. Alternatively, the reflection electrode may be formed on the embossed pattern 105s to increase a reflectivity of the reflection electrode.

The multi-layered organic insulating layer 105 includes the first, second and third organic insulating layers 105a, 105b and 105c having the various refractive indexes, thereby further increasing the reflectivity of the array substrate.

In particular, a first light L1 is reflected from an upper surface of the third insulating layer 105c, and a second light L2 is reflected from an upper surface of the second insulating layer 105b. A third light L3 is reflected from an upper surface of the first insulating layer 105a.

According to embodiments of the present invention, the sizes of the contact holes are decreased, and the number of the contact holes is increased, thereby protecting the gate and data metal layers. That is, the sizes of the contact holes are decreased so that the exposed area of the gate and data metal layers is decreased. In addition, the number of the contact holes is increased so that the contact characteristics of the contact holes are improved.

Furthermore, the inclined side surfaces and the stepped side surfaces are formed adjacent to the pad so that an externally provided terminal can be mounted on the pad, while preventing the misalignment between the externally provided terminal and the pad. Therefore, contact characteristics between the externally provided terminal and the pad are improved. The externally provided terminal may be used for a chip on glass (COG), a chip on film (COF), a flexible printed circuit film (FPC), etc.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. An array substrate comprising:
a first line, a second line and a switching element in a pixel region, wherein the pixel region is defined by the first and second lines adjacent to each other; and
a pixel electrode electrically connected to an electrode of the switching element through a plurality of contact holes, the contact holes partially exposing the electrode of the switching element.

2. The array substrate of claim 1, further comprising an organic insulating layer covering the first and second lines.

3. The array substrate of claim 2, wherein the organic insulating layer comprises a reflective material.

4. The array substrate of claim 2, wherein the organic insulating layer has a multi-layered structure including at least two layers having different refractive indexes.

5. The array substrate of claim 2, further comprising a pad member including:
a pad pattern electrically connected to a metal pattern of the first line through another plurality of contact holes; and
side surfaces of the organic insulating layer which surround the pad pattern, the side surfaces being inclined with respect to a surface of the organic insulating layer.

6. The array substrate of claim 2, further comprising a pad member including:
a pad pattern electrically connected to a metal pattern of the first line through another plurality of contact holes; and
side surfaces of the organic insulating layer which surround the pad pattern, the side surfaces having a stepped portion.

7. The array substrate of claim 2, further comprising a pad member including:
a pad pattern electrically connected to a metal pattern of the second line through another plurality of contact holes; and
side surfaces of the organic insulating layer which surround the pad pattern, the side surfaces being inclined with respect to a surface of the organic insulating layer.

8. The array substrate of claim 2, further comprising a pad member including:
a pad pattern electrically connected to a metal pattern of the second line through another plurality of contact holes; and
side surfaces of the organic insulating layer which surround the pad pattern, the side surfaces having a stepped portion.

9. The array substrate of claim 1, wherein each of the first and second lines comprises molybdenum.

10. The array substrate of claim 1, wherein each of the first and second lines comprises:
a first layer including molybdenum or molybdenum alloy; and
a second layer including at least one selected from the group consisting of aluminum, aluminum alloy, silver, silver alloy, copper and copper alloy.

11. The array substrate of claim 1, wherein the pixel electrode comprises at least one selected from the group consisting of indium tin oxide (ITO), tin oxide (TO), indium zinc oxide (IZO), zinc oxide (ZO) and indium tin-zinc oxide (ITZO).

12. An array substrate comprising:
a pixel part including a first line, a second line, a switching element electrically connected to the first and second lines, and a pixel electrode electrically connected to the switching element; and
a first pad member transmitting an electrical signal to the switching element, the first pad member being electrically connected to a first metal pattern through a plurality of first contact holes, the first metal pattern being formed from substantially the same layer as the first line.

13. The array substrate of claim 12, further comprising a second pad member transmitting an electrical signal to the switching element, the second pad member electrically connected to a second metal pattern through a plurality of second contact holes, the second metal pattern being formed from substantially the same layer as the second line.

14. The array substrate of claim 12, wherein the pixel part further comprises a contact part having a plurality of contact holes through which a drain electrode of the switching element is electrically connected to the pixel electrode.

15. The array substrate of claim 13, further comprising an organic insulating layer covering the first and second lines.

16. The array substrate of claim 15, wherein the organic insulating layer comprises a reflective material.

17. The array substrate of claim 15, wherein the organic insulating layer has a multi-layered structure including at least two layers having different refractive indexes.

18. The array substrate of claim 15, wherein the first pad member comprises:
a first pad pattern being electrically connected to the first metal pattern through the first contact holes; and
side surfaces of the organic insulating layer which surround the first pad pattern, and the side surfaces are inclined with respect to a surface of the organic insulating layer.

19. The array substrate of claim 15, wherein the second pad member comprises:
a second pad pattern being electrically connected to the second metal pattern through the second contact holes; and
side surfaces of the organic insulating layer which surround the second pad pattern, and the side surfaces are inclined with respect to a surface of the organic insulating layer.

20. The array substrate of claim 15, wherein the first pad member comprises:
a first pad pattern being electrically connected to the first metal pattern through the first contact holes; and
side surfaces of the organic insulating layer which surround the first pad pattern, and each of the side surfaces has a stepped portion.

21. The array substrate of claim 15, wherein the second pad member comprises:
a second pad pattern being electrically connected to the second metal pattern through the second contact holes; and
side surfaces of the organic insulating layer which surround the second pad pattern, and each of the side surfaces has a stepped portion.

22. A method of manufacturing an array substrate comprising:
forming a switching element electrically connected to a line in a display region of the substrate;
forming a metal pattern electrically connected to the line in a peripheral region of the substrate;
forming a passivation layer on the substrate having the switching element and the metal pattern;
partially etching the passivation layer to form a plurality of first contact holes through which the switching element is partially exposed, and a plurality of second contact holes through which the metal pattern is partially exposed;
forming a pixel electrode electrically connected to the switching element through the first contact holes; and
forming a pad pattern electrically connected to the metal pattern through the second contact hole.

23. The method of claim 22, wherein the line comprises molybdenum or molybdenum alloy.

24. The method of claim 22, wherein, after the partially etching the passivation layer, the method further comprises:
forming an organic insulating layer on the passivation layer; and
removing all of the organic insulating layer corresponding to the first contact holes and the metal pattern, and removing part of the organic insulating layer corresponding to a peripheral region of the metal pattern to form a stepped portion in the organic insulating layer.

25. The method of claim 24, wherein removing all of the organic insulating layer comprises:
fully exposing the organic insulating layer corresponding to the metal pattern; and
developing the fully exposed organic insulating layer.

26. The method of claim 24, wherein removing part of the organic insulating layer comprises:
partially exposing the organic insulating layer corresponding to the peripheral region of the metal pattern; and
developing the partially exposed organic insulating layer.

27. The method of claim 24, further comprising removing part of the organic insulating layer corresponding to the display region to form an embossed pattern.

28. The method of claim 24, wherein the organic insulating layer comprises a reflective material.

29. The method of claim 24, wherein the organic insulating layer has a multi-layered structure including at least two layers having different refractive indexes.

30. The method of claim 22, wherein the pixel electrode is formed from a substantially same layer as the pad pattern.
